(19) United States
(12) Patent Application Publication
(10) Pub. No.: US 2017/0046836 A1
(43) Pub. Date: Feb. 16, 2017

(54) REAL-TIME ENDOSCOPIC IMAGE ENHANCEMENT

(71) Applicant: BIOSIGNATURES LIMITED, Newcastle upon Tyne (GB)

(72) Inventors: David Ian BRAMWELL, Newcastle upon Tyne (GB); Benjamin Timothy CHAFFEY, Newcastle upon Tyne (GB); Mark Andrew LAMBERT, Gateshead (GB)

(73) Assignee: Biosignatures Limited, Newcastle upon Tyne (GB)

(21) Appl. No.: 15/305,983

(22) PCT Filed: Apr. 14, 2015
(86) PCT No.: PCT/GB2015/051128

§ 371 Date: Oct. 21, 2016

(30) Foreign Application Priority Data
Apr. 22, 2014 (GB) 1407078.3

(51) Int. Cl. G06T 7/00; G06T 5/40

(52) U.S. Cl. CPC G06T 7/0012; G06T 5/40; G06T 2207/10068

(57) ABSTRACT

There is provided a method for enhancing endoscopic image data, comprising the steps of: (a) receiving a plurality of image frames from an imaging section of an endoscope apparatus at a predetermined frame rate; (b) converting said plurality of image frames into a plurality of digital image frames at said predetermined frame rate; (c) applying at least one active Look-up-Table, comprising at least one first transform, to at least part of said plurality of digital image frames at said predetermined frame rate, so as to generate a plurality of enhanced digital image frames; (d) providing said enhanced digital image frames to a display at said predetermined frame rate; (e) generating at least one optimised Look-up-Table, comprising at least one second transform that is optimised utilizing at least one image parameter of a predetermined quantity of said plurality of digital image frames; (f) updating said at least one active Look-up-Table with said at least one second transform; (g) executing step (c) for said predetermined quantity of a subsequent plurality of digital image frames; (h) repeating steps (e) to (g) for successive integer multiples of said predetermined quantity of said plurality of digital image frames, and wherein steps (e) to (h) are executed in parallel to steps (a) to (d).

The present invention relates generally to the field of medical imaging and more specifically to endoscopic image processing. In particular, the present invention relates to real-time image enhancement of endoscopic video images, and a video endoscope adapted to provide enhanced endoscopic video images together with the unprocessed endoscopic video images.

Introduction

Endoscopy means “looking inside” and typically refers to clinical examination of the interior of the body using an endoscope. This so called clinical endoscopic examination (CEE) provides a relatively rapid and minimally invasive way to visually examine the interior of the body and is now widely used to diagnose and monitor diseases, but may also be used to inspect any other interior of a closed volume, such as, for example, cylinders, tubes and spheres in any viable setting. Accordingly, CEE is often regarded as a “gold standard” investigation.

Typically, an optical endoscope comprises an image guide in form of a rigid or flexible tube and a lens system adapted to transmit the image from the objective lens to the operator via an eyepiece. The image guide may include a light delivery system, i.e. a relay lens system in the case of rigid endoscopes, or a bundle of fibre optics in the case of a flexible fiberscope. Additional channels are often provided to allow entry of tools or manipulators (usually in rigid endoscopes) to the interior cavity.

In modern instruments, the eyepiece may be replaced by a camera (e.g. a charge-coupled device, also known as CCD) that captures the transmitted images to be displayed on a screen which can then be viewed by the operator. FIG. 1 shows an example of an endoscopic imaging system 10 comprising a flexible image guide 12, a camera 14 and eyepiece 16, as well as, a video screen 18 adapted to display digital images provided by an image processor 20. Recently, other systems have emerged where the CCD camera is positioned at the tip of the endoscope making the optical guide unnecessary.

In the clinical environment, CEE is often performed in an outpatient setting with local anaesthesia. In order to minimise patient discomfort (as may be experienced in a Cystoscopy), thin and flexible systems (i.e. small diameter and steerable guides) are favoured. The applied light is usually from a broad spectrum white source, with the “raw” and unprocessed video signal being displayed on a nearby screen. Consequently, commonly used endoscopes generally provide a limited field of view, non-intuitive motion control and relatively low-contrast video images in a colour space with relatively poor colour gamut. Accordingly, commonly used systems may have a relatively high sensitivity for protruding features, but exhibit a relatively low sensitivity for flat lesions. Flat lesions, often much more serious, typically invade tissues laterally and manifest a slight discolouration in portions of the video image, making it difficult to detect.

Cystoscopy

Bladder cancer is one of the most common cancers by incident rate in the UK and often recurs post-treatment. Consequently, patients often undergo regular CEE over a long period of time in order to monitor and potentially re-treat lesions, leading to the highest per-patient costs of care from diagnosis to death of any cancer.

In practice, flexible Cystoscopy allows a relatively non-invasive (though uncomfortable and unacceptable to some patients) internal examination of the internal bladder surfaces by simply introducing a light into the bladder via a flexible controllable tube and providing an image externally to the urologist via an optics system. Most systems use a coherent fibre optic bundle relaying the images to an eyepiece in a control handset that is operated by the user. Though, as mentioned previously, it is now common practice for camera attachment points to be integrated into the system, allowing the endoscopic images to be presented via video screens and/or recorded in video format.

However, because of the limitations currently available systems have, the range of colours and contrast within the visual images is not optimal, i.e. several shades of red running through to some yellow and white make it hard to discriminate subtle features, such as carcinoma, from the background.

In particular, the subtle features defining, for example, a carcinoma (which may be much more alarming than protruding features) are a lot harder to spot, because there is no visible distortion or protrusions from the bladder wall itself Similarly, when performing follow-up examinations, potential changes within the bladder wall may not be picked up easily by the examiner, because it is difficult to objectively compare changes within the wall from visit to visit (even when the visits are only one month apart). In the event a different examiner (i.e. urologist) performs a subsequent CEE, spotting small changes is essentially impossible.

As a result, many attempts have been made to improve CEE, for example, through the use of various fluorescent dyes, which selectively attach to certain tissue types, or lighting manipulation (e.g. narrow-band illumination), so as to manipulate the contrast between certain fixed image types based on respective differential optical properties under the narrow-band illumination. However, in the case of narrow-band illumination, the improvement often comes at the cost of a decreased general contrast of the images.

In order to improve objective detection of chronological changes, endoscopic video images may be recorded (e.g. DVD) for later examination using suitable image processing tools. However, the video images recorded with commonly available and used systems, and which are in common formats such as DVD/MPEG, suffer from relatively low resolution and artefacts, potentially introduced when compressing the images using lossy algorithms. Moreover, video images that are stored on removable data storage devices, such as hard discs or DVD, are effectively “locked away” and may only be accessible, if the physical disc is to hand at that time.

Consequently, the practical usefulness of externally recorded video images is limited significantly, and the absence of suitable recording systems further complicates the issue of sharing any examination findings with colleagues, or compare recent observations with historical records.

Accordingly, it is an object of the present invention to provide a method and system capable of enhancing endoscopic images, such as, for example, endoscopic video images, and display the enhanced images to the operator in real-time (i.e. live) and synchronous with the captured unprocessed endoscopic images (optionally).

### SUMMARY OF THE INVENTION

Preferred embodiment(s) of the invention seek to overcome one or more of the above disadvantages of the prior art.

According to a first aspect of the invention there is provided a method for enhancing endoscopic image data, comprising the steps of:

(a) receiving a plurality of image frames from an imaging section of an endoscope apparatus at a predetermined frame rate;

(b) converting said plurality of image frames into a plurality of digital image frames at said predetermined frame rate;

(c) applying at least one active Look-up-Table, comprising at least one first transform, to at least part of said plurality of digital image frames at said predetermined frame rate, so as to generate a plurality of enhanced digital image frames;

(d) providing said enhanced digital image frames to a display at said predetermined frame rate;

(e) generating at least one optimised Look-up-Table, comprising at least one second transform that is optimised utilizing at least one image parameter of a predetermined quantity of said plurality of digital image frames;

(f) updating said at least one active Look-up-Table with said at least one second transform;

(g) executing step (c) for said predetermined quantity of a subsequent plurality of digital image frames;

(h) repeating steps (e) to (g) for successive integer multiples of said predetermined quantity of said plurality of digital image frames, and wherein steps (e) to (h) are executed in parallel to steps (a) to (d).

This provides the advantage that complex image processing (i.e. image enhancement) can be performed on a “live” video stream and the enhanced video images can be provided in real-time and synchronous with the unprocessed video images, allowing the examiner (e.g. urologist) to view and compare unprocessed (original) and visually enhanced video images during examination. In particular, when processing video images in real-time, any calculations (e.g. digitising, analyses, filtering etc.) have to be completed within a fixed time interval that is less than the frame rate of the video stream. For example, PAL video presents whole frames at a rate of 25 Hz (i.e. 25 frames per second), allowing a maximum of 40 milliseconds (ms) for each frame to be digitised, processed and enhanced. Thus, if the image processing per frame takes slightly more than 40 ms, the output frame rate will be halved. The method of the present invention ensures that the time interval remains constant, because the video images are enhanced by simple input to output mapping utilising Look-up-Tables (LUT), which can always be completed within the required time interval (e.g. 40 ms for 25 Hz frame rate) and regardless of the complexity of generating the transform for the LUTs. In other words, the endoscopic imaging system is capable of always providing video frames at the full frame rate, wherein, LUT transforms applied to individual video frames or scenes can be optimised and updated at a slower effective rate without affecting the “live” video output.

As a result, any available and/or suitable image enhancement technique may be used to optimise image enhancement of individual images and/or predetermined video scenes and/or in predetermined regions of individual images or video scenes, without compromising the real-time video output.

Advantageously, the at least one active Look-up-Table may comprise a plurality of spatially separated Look-up-Tables, each comprising respective said at least one first transform. Even more advantageously, each one of said plurality of spatially separated Look-up-Tables may be designated for a predetermined region of any one of said plurality of digital image frames.

This provides the advantage of an improved image enhancement, because individual LUTs can be generated for specific regions of interest in one or more image frames, i.e. the individual LUTs are optimised for the predetermined regions, allowing optimal image enhancement “tailored” to individual features in the region of interest.

Advantageously, step (f) may include generating a temporal sequence of a plurality of transition-transforms adapted to provide a smooth transition from said first transform of said active Look-up-Table to said second transform of said optimised Look-up-Table. Preferably, the smooth transition may be executed over said predetermined quantity of said subsequent plurality of digital image frames.

This provides the advantage of minimising potential visual artefacts in the “live” video stream. In particular, when updating the “currently active” LUT with the next target LUT, the differences between the two LUTs may be large enough to create visual artefacts if the transition is executed instantaneously. Thus, updating the active LUT in smaller increments over a number of frames minimises the risk of visual artefacts occurring during the LUT update. The transition period (i.e. number of frames and increments) may be made dependent on the difference between the currently active LUT and the subsequent target LUT. Also, the transition period used to update the currently active LUT allows sufficient time to calculate the next target LUT. For example, an optimised target LUT may require ten frames to be calculated. A smooth transition from the current to the target LUT is then generated across ten frames, with the target LUT fully realised at the tenth frame (at which point the next new target LUT will be ready to be “transitioned” across the subsequent number of frames).

Alternatively, step (e) may be executed offline, utilizing a predetermined quantity of practice digital image frames. This provides the advantage that an imaging system can be “primed” to an expected image format and/or quality in advance to its use in, for example, a CEE, therefore allowing optimised image enhancement for the start of the examination.

Advantageously, the method may further comprise the step of:

(a-₁) initialising a first of said at least one active Look-up-Table prior to step (a). Preferably, the first of said at least one active Look-up-Table may comprise a null-transform.

This provides the advantage that the imaging system does not require prior “priming” to an expected image format and/or quality, allowing the system to optimise the applied LUTs to the “live” images.

Alternatively, step (a-₁) may be executed offline.

Advantageously, the at least one second transform may be optimised utilizing any one of a gamma correction, histogram equalisation, contrast limited adaptive histogram equalisation, fixed contrast enhancement and feature segmentation by colour properties.

Alternatively, the at least one active Look-up-Table and/or said at least one optimised Look-up-Table may be adapted to provide a predetermined transform at a predetermined threshold value of said at least one image parameter. In another alternative, the at least one second transform may be optimised according to a combination of R, G, B values of each one of said plurality of digital image frames.

Typically, the predetermined frame rate may be a fixed frame rate.

According to a second aspect of the invention there is provided an endoscopic imaging system adapted to enhance endoscopic image data by a method according to the first aspect of the present invention.

According to a third aspect of the invention there is provided a computer readable storage medium having embodied thereon a computer program, when executed by a computer processor that is configured to perform the method of the first aspect of the present invention.

### BRIEF DESCRIPTION OF THE DRAWINGS

Preferred embodiments of the present invention will now be described, by way of example only and not in any limitative sense, with reference to the accompanying drawings, in which:

FIG. 1 shows a typical endoscopic imaging system with flexible image guide, camera/eyepiece interface, processor and video monitor;

FIG. 2 shows a simplified illustration of an example of a “contrast” Look-up-Table (LUT) applied to a digital image;

FIG. 3 shows an illustration of a typical image histogram, i.e. a frequency distribution chart of the pixel values of an image;

FIG. 4 shows an illustration of the histogram equalisation technique (a) before and (b) after equalisation, e.g. for contrast adjustment of an image;

FIG. 5 shows and illustration of the more advanced Contrast Limited Adaptive Equalisation Histogram technique, also known as CLAHE;

FIG. 6 shows a flowchart of the basic method of the present invention utilising a Look-up-Table (LUT) determined prior to starting examination;

FIG. 7 shows a flowchart of the alternative step of “priming” the imaging system prior to use, including “offline” learning on pre-recorded video images;

FIG. 8 shows a flowchart of the preferred method of the present invention including “on-going” updating of the Look-up-Table (LUT) during examination;

FIG. 9 shows a schematic illustration of the “update” and “smoothing” step of the method of the present invention;

FIG. 10 shows an example of (a) a non-enhanced video image frame and (b) the enhanced video image frame as seen by the examiner in real-time during examination, and

FIG. 11 shows an example an endoscopic imaging system adapted to perform real-time image enhancement and selectively display the enhanced video, or the original video synchronous with the enhanced video.

### DETAILED DESCRIPTION OF THE PREFERRED EMBODIMENT(S)

The exemplary embodiments of this invention will be described in relation to clinical endoscope examination and, in particular, to cystoscopy. However, it should be appreciated that, in general, the method, system and software of this invention will work equally well for any other imaging requiring real-time image processing.

For purposes of explanation, it should be appreciated that the terms ‘determine’, ‘calculate’ and ‘compute’, and variations thereof, as used herein are used interchangeably and include any type of methodology, process, mathematical operation or technique. The terms ‘generating’ and ‘adapting’ are also used interchangeably describing any type of computer image processing for enhancing visual representation of images. In addition, the term ‘pixel’ is understood to mean a picture element, or the smallest unit of a display memory that can be controlled. The term ‘real-time’ is understood to mean processing and outputting data at the same rate as received data is outputted without processing. The terms ‘online’ and ‘live’ are used interchangeably meaning when the system is in use, e.g. during examination. The term ‘mapping’ is understood to apply a transform (LUT), i.e. assigning new pixel values to at least part of the image pixels.

The imaging system of the present invention allows visually enhanced video images to be displayed in parallel (i.e. in real-time) with the original “raw” video input, potentially providing valuable information to clinicians during CEE. In particular, the imaging system of the present invention may assist the clinician at the point of diagnosis and care by providing additional enhanced visualisation of the live video image, potentially highlighting areas that warrant more detailed examination. Furthermore, the “on-board” recording of the synchronous enhanced and “raw” video images facilitates structured off-line review, longitudinal monitoring and health record integration.

In a basic embodiment of the present invention, the endoscopic imaging system applies image enhancing (e.g. enhanced contrast) Look-up-Tables (LUT) to the input video images in real-time, i.e. within a time interval that is less than the frame rate of the input video images (e.g. at 25 Hz, <40 ms). The use of LUTs allows the application of transforms (spatially localised or to the whole image) that could be generated from any suitable image enhancement scheme, wherein the more complex and time-consuming image analysis and processing is run outside the real-time constraints, i.e. in parallel but without the frame rate limitations.

Look-Up-Tables (LUT)

In image processing, a LUT is used to transform the input data (e.g. pixel values of a digital image) into a more desirable output format (e.g. adjusted pixel values to achieve visual enhancement of the image), i.e. the LUT “encodes” the most optimal transform given some predefined specification of optimality and recent frame history. For example, a colour picture may be transformed into a greyscale picture or vice versa, or, a lower contrast picture may be transformed into a higher contrast picture.

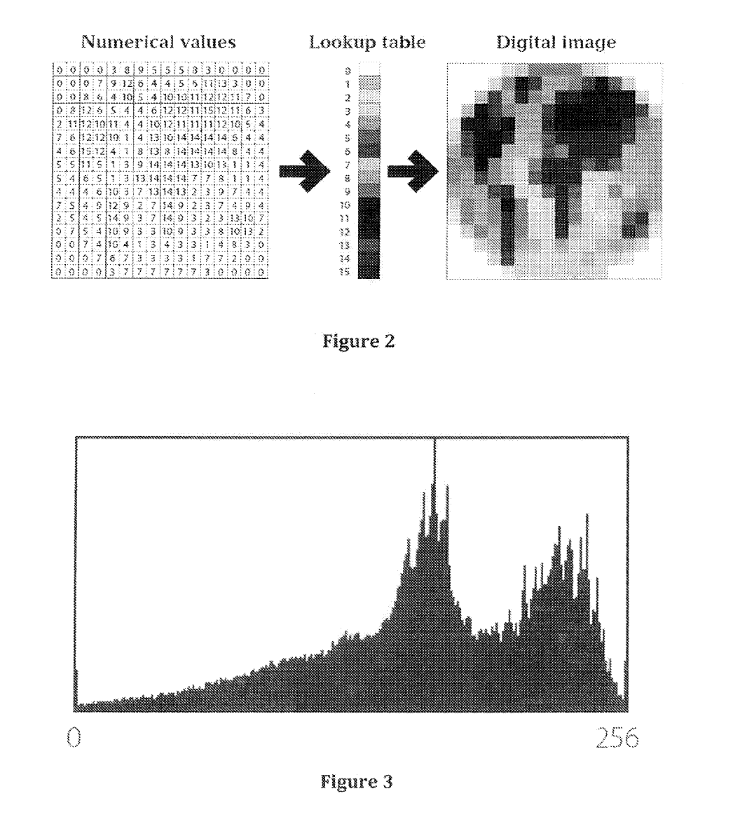

FIG. 2 shows an illustration of an example of transforming the coloured pixels (defined by numerical values) into a greyscale picture using the LUT. The transfer function (i.e. transform) may be a linear function, e.g. simply assigning colour values to equivalent greyscale values, or it may also be a more complicated function resulting from a complex image analysis and processing, e.g. when attempting to enhance certain aspects of an image (e.g. contrast).

In addition, a LUT applied to the image may comprise multiple LUTs applied to different spatial locations across the image.

Thus, when processing an image (e.g. when aiming to adjust the contrast), any suitable image processing technique and/or algorithm may be utilised. Commonly used image processing techniques, especially when enhancing contrast, includes a histogram equalisation, which is now described in more detail.

Histogram Equalisation and CLAHE

Several contrast enhancement schemes that are routinely used in image processing to achieve simple contrast enhancement may include, for example, measuring the minimum and maximum values in each of the red, green and blue channels and simply multiply and shift the intensity values in order to span the available range, though, this technique alone may not produce a very useful enhancement. Another known technique may be applying a nonlinear multiplicative function, so as to shift the intensity values by a pre-determined set of values, such as performed in gamma correction. Again, this technique alone may not produce a useful enhancement either.

Consequently, a more adaptive technique such as histogram equalisation is commonly applied. When performing histogram equalisation, a histogram of the image(s) is generated first. Generally, each pixel in an image has a colour that has been produced by some combination of the primary colours red, green, and blue (RGB). Furthermore, each of the colours may have a brightness value ranging from 0 to 255. In a digital image this will require a bit depth of 8-bits. A histogram is then created by the computer scanning through each of the image's RGB brightness values and counting how many are at each level from 0 to 255. An example of a typical histogram is shown in FIG. 3.

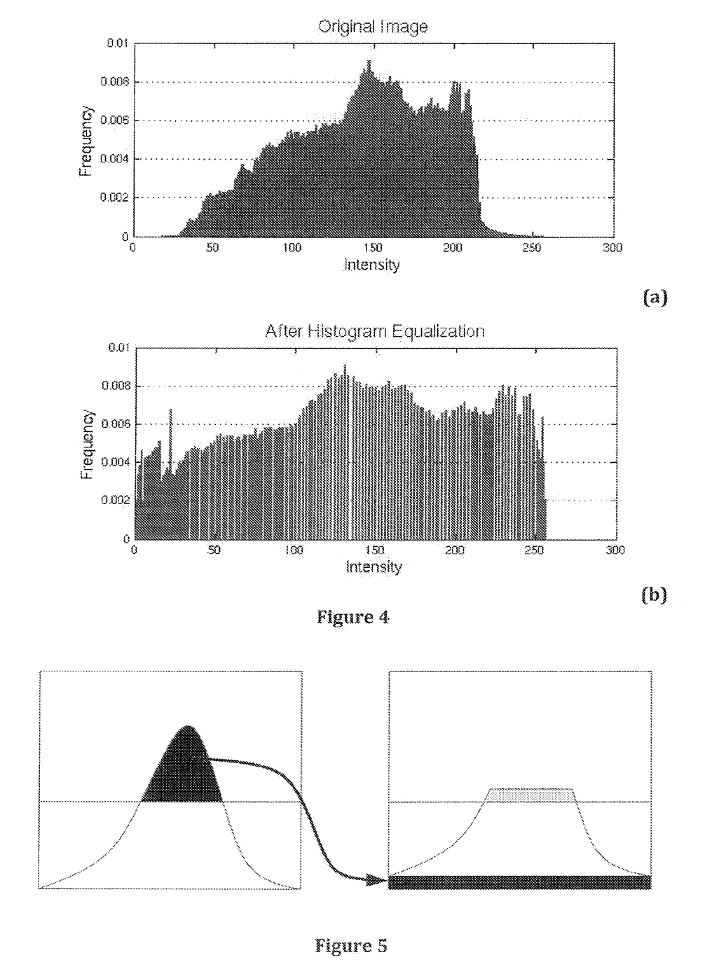

After the histogram has been determined, the intensity values of the image are distributed cumulatively over the whole range (i.e. “the intensity range is stretched out”). An illustration of a simple histogram equalisation is shown in FIG. 4 (a) and (b), where the intensities of the original image histogram are spread over the whole range. The histogram may also be calculated separately for each colour channel, and an algorithm is then utilised to “flatten” each individual histogram in order to “spread” the values as evenly as possible across the available output range.

However, one of the disadvantages of global histogram equalisation is that it has the tendency to over-amplify noise in relatively homogenous regions of the image. That is, the contrast at smaller scales is enhanced and the contrast at larger scales is reduced. Therefore, more advanced techniques, such as adaptive histogram equalisation or contrast limited adaptive histogram equalisation (CLAHE), can be used to minimise the disadvantages and further improve image enhancement.

CLAHE, for example, limits each intensity level to a predetermined maximum value, so that any value exceeding the maximum value is uniformly distributed to the remaining levels. This is illustrated in a simplified example shown in FIG. 5. In particular, the amount of “stretching” that is allowed is limited, therefore, reducing the low contrast scene artefacts, and a different histogram equalisation scheme may be applied across each different sections of the image, assisting to enhance the image in relatively badly lit peripheral areas.

In summary, suitable image processing techniques requiring no frame analysis may include any one of the following:

Null Transform:

The input values simply map to the output values. The LUT never changes.

Red Channel:

The green and blue channels are set to zero regardless of their input values resulting in a display of just the red component (similarly for green or blue and also for the creation of a greyscale representation).

Gamma Correction:

The input values of each channel map to output values calculated via an exponential transform of the input values.

Fixed Contrast Enhancement:

Input values are mapped to output values based on a contrast enhancement transform.

In summary, suitable image processing techniques requiring frame analysis may include any one of the following:

Global Histogram Equalisation:

The range of values in the input frames are analysed and shifted to use as much of the available output range as is possible (the same LUT is applied across the whole image).

Smoothed Global Histogram Equalisation:

Same as global histogram equalisation, except the mapping is constrained by a frame history (which reduces the appearance of false colour artefacts when there is a sudden drop in scene dynamic range).

Adaptive Histogram Equalisation:

The same as global equalisation, except that the frame is sub-divided into areas that can be enhanced in a more independent manner (in practice the histograms will be spatially smoothed to avoid visible artefacts at the borders of areas).

Contrast Limited Adaptive Histogram Equalisation (CLAHE):

This is an extension to adaptive histogram equalisation, where limits are imposed on the degree of contrast enhancement that is allowed (again, usually to avoid visual artefacts in low contrast scenes and the detrimental enhancement of noise).

Feature Segmentation by Colour Properties:

A set of complex algorithms may be used to determine colour space sub-spaces that represent features to be highlighted in the video stream. The sub regions may be mapped to a fixed colour (or all non-matching regions may be mapped to a fixed colour).

### METHOD(S) OF THE PRESENT INVENTION

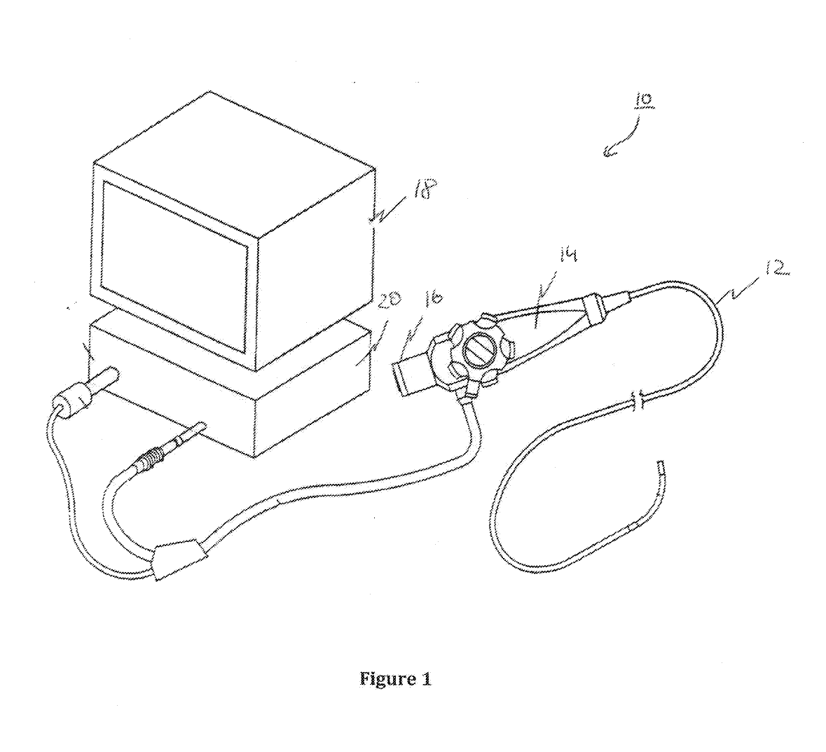

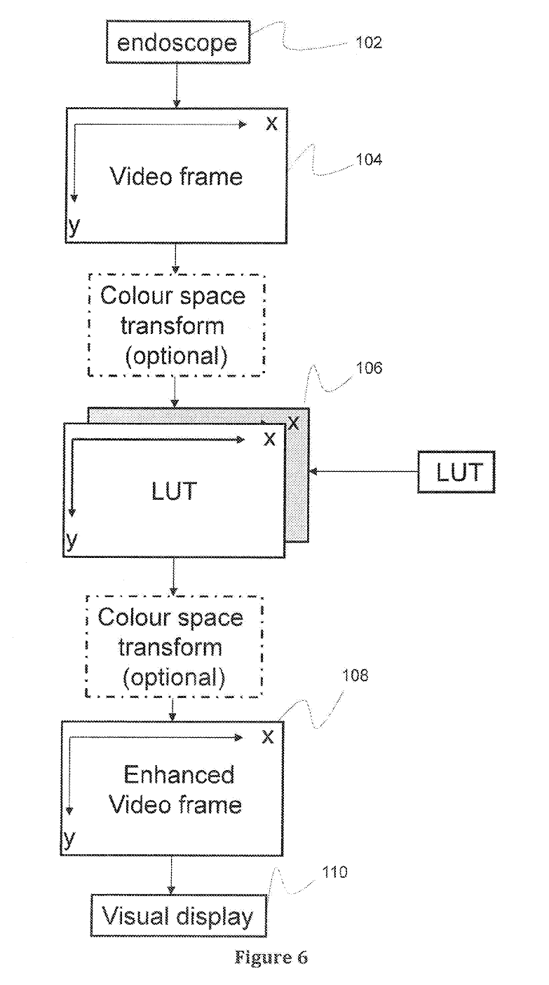

FIG. 6 shows a simplistic flowchart used to describe the basic principle behind the method of the present invention. In particular, the flowchart in FIG. 1 describes real-time image enhancement (image contrast in particular) utilising at least one LUT 106 that may have been generated offline prior to the start of the CEE.

As shown in FIG. 6, images provided by an endoscope 102 are digitised by a suitable capture card, wherein the captured frame 104 and frame rate depend on the video signal supplied by the endoscope system 102 (e.g. standard definition interlaced PAL is 768 pixels wide by 576 pixels high at 25 frames per second). In this particular example, the video frame is digitised into 768×576 pixel 24 bit RGB images, but higher resolutions, such as HD, may be used.

The LUT 106 then takes an input value and replaces it with another value based on a corresponding entry in the list of the LUT. In an example, the list may be 256 entries long for each of the R, G and B channels, corresponding to an 8 bit resolution for each of them. The LUT may also be spatially correlated where different image locations (i.e. x, y locations) may perform different value mapping for the same input combination. Thus, in its full spatial resolution form the LUT contains three full 256 entry tables at every pixel, i.e. one entry table for each of the R, G and B channels (optionally). Also, the LUT may be at a lower spatial resolution, wherein intermediate values are generated via “nearest neighbour interpolation”.

For example, an 8 bit R, G, B representation therefore requires 768 bytes storage (256+256+256) for each spatial location, which for a 768×576 pixel standard definition video frame represents approximately 324 MB of storage. Also, many endoscope systems do not use the whole video frame, generally showing a square image (the remainder of the image simply blacked out) and the LUT simply covers the “active” area.

It is understood that the LUT may perform many useful image processing functions very rapidly depending on its contents. An individual LUT for each colour component example given can support many image processing functions where the colour channels can be assumed as independent. For example, global histogram equalisation may be achieved simply by calculating the single histogram equalisation LUT for the frame as a whole (for each channel individually) and then copy the LUT to every location. Certain false colour maps may be produced in a similar fashion. Image “thresh-holding” may also be performed by arranging for the LUT to always map to a fixed colour whenever certain ranges are exceeded. Similarly, gamma correction, and CLAHE may also be supported.

More complex LUT designs may be used to better support output values that are dependent on the input combination of the R, G, B values.

The enhanced video frame 108 is produced at the same frame rate as the input video frame 104, allowing both non-enhanced and enhanced video frames to be displayed 110 in real-time, in order to assist the examiner during examination.

In its most basic form, the LUT 106 may simply be a NULL operator, where the input values “map” to the same output values. However, an “enhancing” LUT (used throughout the whole session) may be generated using “training images” of similar quality and content to the expected examination. This method will provide a general enhancement of the “live” video stream, but is not adaptive to changes in image quality.

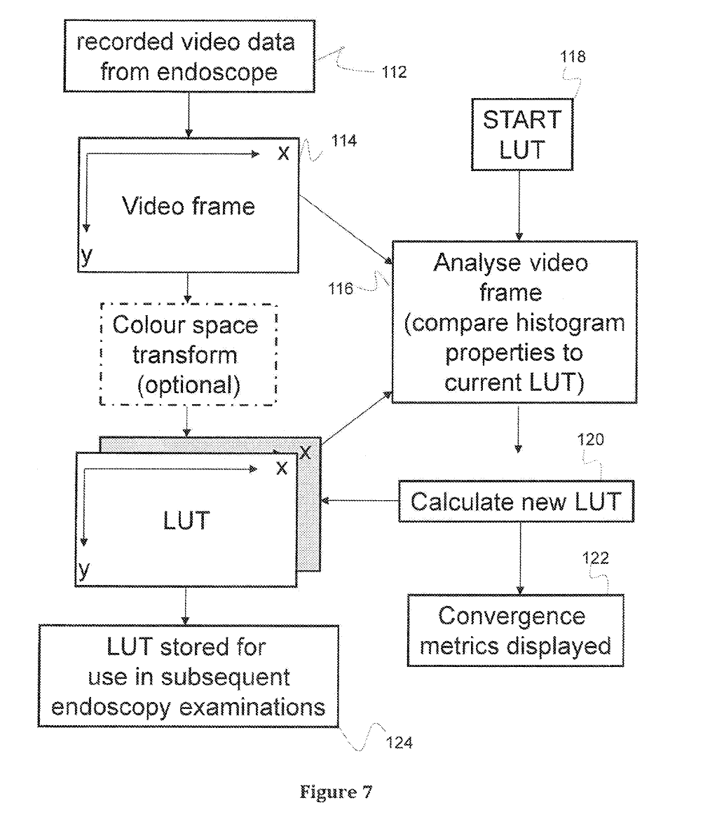

FIG. 7 shows an example flowchart of how an initial LUT may be determined “offline” from a previously recorded endoscope session 112 by “learning” the optical and lighting properties of the clinical system to be used in the examination. Multiple recorded video data may be presented to the system during the “learning” session. In particular and similar to the flowchart described in FIG. 6, the recorded video data 112 is digitized and the captured frame 114 is then analysed 116 using an initial LUT 118 to compare the subsequent histogram properties in order to calculate a new LUT 120. Convergence metrics may be displayed 122 in order to highlight the rate of change of the LUT entries, providing the operator with the “status of learning”. The converged LUT's are then stored 124 to be used for subsequent CEE sessions.

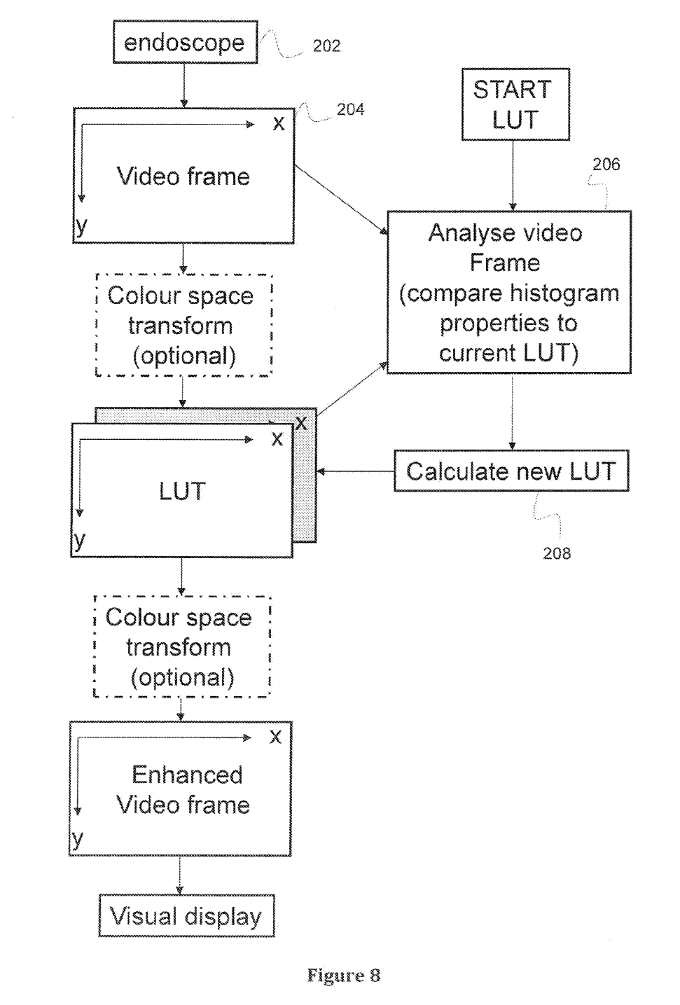

FIG. 8 shows the preferred embodiment of the method of the present invention, where the LUT is updated “on going” during “live” examination. In particular, and equivalent to the flowchart in FIG. 6, endoscope 202 provides the video signal to be digitised into predetermined video frames 204. Initially the video frame 204 is processed using an initial LUT (e.g. NULL LUT). In parallel to the real-time video streaming an optimised LUT is then determined by analysing 206 the active video frame(s) (i.e. comparing histogram properties to the active LUT) and replacing the currently active LUT with a new LUT 208, optimised for a predetermined number of video frames. To avoid visual artefacts, the “replacing” of the currently active LUT is executed so as to smoothly update the LUT from the active LUT to the new optimised LUT over a predetermined number of video frames. Preferably, over the same number of video frames required to determine the optimised LUT.

For example, considering a situation where a new optimised LUT takes 10 frames to calculate, a smooth transition is calculated between the currently active LUT and the new optimised LUT, wherein the content of the “live” active LUT is updated by smaller increments across the 10 frames, i.e. frame 0 has the “currently active” LUT, frame 5 is half way between the “currently active” LUT and the new optimised LUT, and frame 10 will have the new optimised LUT fully realised (at which point a new target LUT will be ready to be transitioned). The “step-by-step” execution by the imaging system may be as follows:

(i) Load LUT with NULL transform;

(ii) Analysis of the first frame calculating the enhancement (in terms of histogram equalisation this involves counting the pixels at each of the 256 possible values for each of the R, G, B channels independently, and then calculating a mapping that equalises the input values as much as possible across the available levels);

(iii) Comparison of the original LUT where, for example, the input R value of 50 was mapped to 50 in the NULL transform, but which is now mapped to 60 when utilising the optimised LUT; (iv) Calculation of a transition LUTs over 10, i.e.:
LUT R 50 ->51 (frame n+1)
LUT R 50 ->52 (frame n+2)
LUT R 50 ->53 (frame n+3)
LUT R 50 ->54 (frame n+4)
LUT R 50 ->55 (frame n+5)
LUT R 50 ->56 (frame n+6)
LUT R 50 ->57 (frame n+7)
LUT R 50 ->58 (frame n+8)
LUT R 50 ->59 (frame n+9)
LUT R 50 ->60 (frame n+10)
wherein n being the frame at which the next optimised LUT is available.

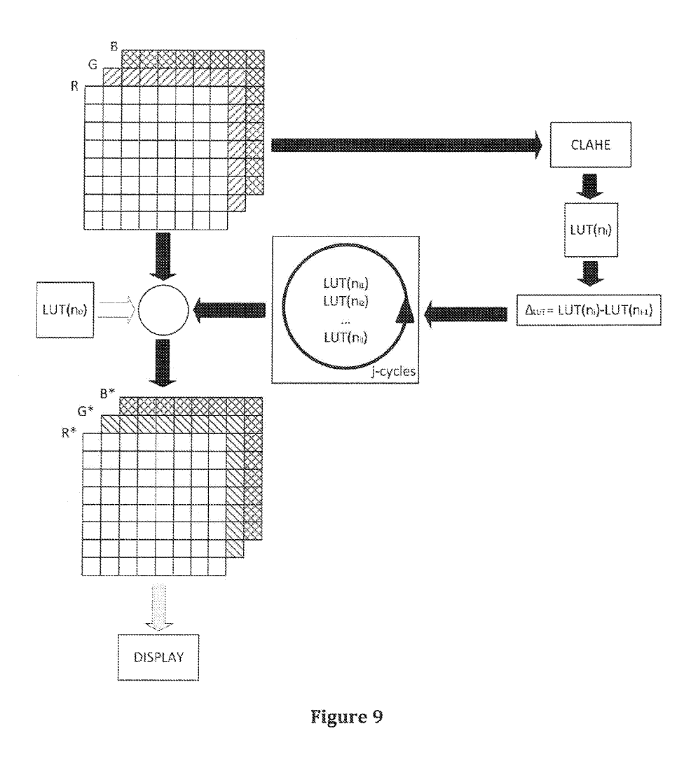

FIG. 9 shows a schematic illustration of the LUT “update” and “smoothing” process, wherein LUT(n₀) is the NULL transform applied at the initialisation and LUT(nij) is the ‘i’ optimised LUT applied over j′ transition LUTs [‘i’-integer numbers for optimised LUTs, ‘j’-integer numbers for transition LUTs], R, G, B are the red, blue and green channel of the input video image and R*, G*, B* are the red, blue and green channel of the enhanced output video image.

Updating the “active” LUT in this manner is therefore independent of the underlying complexity that went into calculating the new optimised LUT, hence ensuring that the real-time frame rates are always maintained.

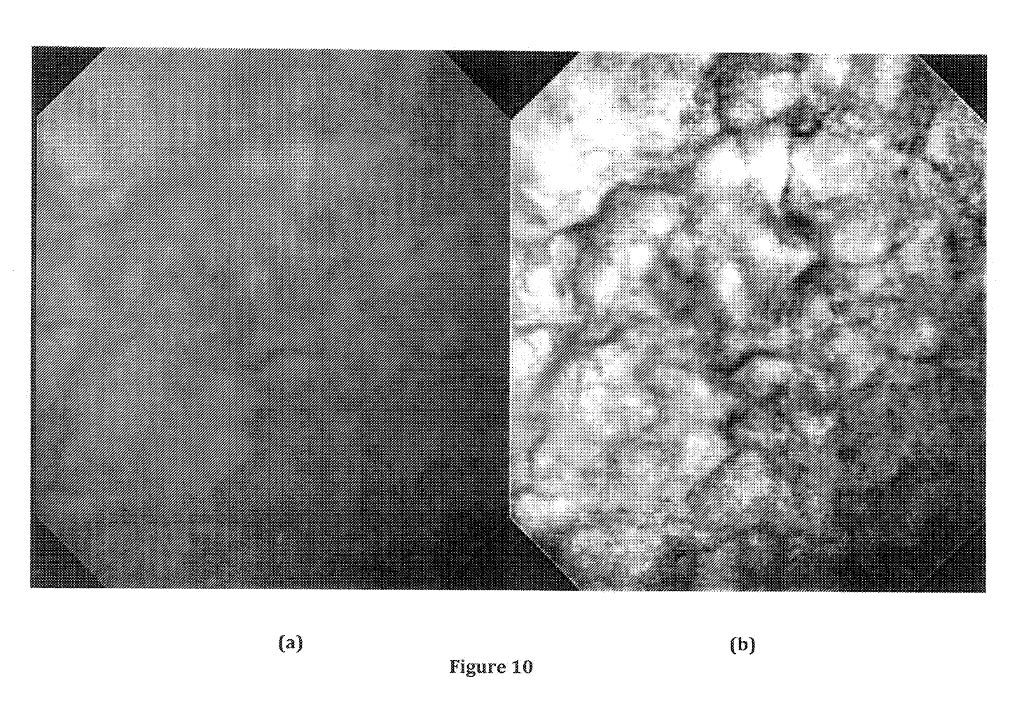

FIG. 10 shows a greyscale representation (in practice, a colour representation is used) of a non-enhanced “raw” video image frame and an enhanced video image frame of the same bladder area. The non-enhanced “raw” video image frame may be displayed on monitor 1 and the enhanced video image frame may be displayed on monitor 2.

Hardware Implementation of a Preferred Endoscopic Imaging System

The endoscopic imaging system of the present invention may be deployed in a clinical setting via a specified combination of compatible computing hardware and custom software. Any currently available and suitable standard endoscopy equipment stack may be retro-fitted to provide the advantages of the present invention. For example, computer hardware adapted to perform the present invention may be connected to a standard endoscopy equipment stack just prior to examination. Since current video enabled endoscopy systems will usually feed the output from the camera system into a hardware unit (that may also provide recording capabilities via DVD-R) and a standard video signal is usually produced by that hardware unit, the video output signal from this unit may instead be directed to the specified computer hardware, where the video images are digitised, processed and then provided to a monitor for display.

The video output from the endoscopic imaging system of the present invention may be presented on multiple displays and may consist of the original “raw” video stream (full screen on the first display) and/or the desired enhanced video stream (full screen on the second display) and/or a montage of available visualisations on a third display. In addition, the endoscopic imaging system of the present invention is capable of recording the video stream (optionally) in a lossless manner (unlike DVD-R) and scenes may be marked for later review interactively by the operator. A later review of the video stream may use the same configuration of displays, but may also allow more flexible control of playback (e.g. frame by frame advancement) and selection of alternate processing visualisations.

Furthermore, the endoscopic imaging system of the present invention may allow a montage of processing options including a collection of visualisation strategies selected from predefined image processing operations such as, for example, colour space manipulations (limited colour histogram equalisation, fixed colour transforms etc.), feature enhancement (e.g. vein enhancement, shape detection etc.) and multiple frame operations (e.g. pixel averaging, statistical temporal filters etc.). Though, multiple frame operations will require the examiner to hold the scope tip stable for a predetermined number of video frames to allow visual image enhancement.

It will be understood by the person skilled in the art that the system is capable of handling various video formats (e.g. DVD) and is adapted to perform any required standard imaging processing of the video streams (e.g. de-interlacing saturated area/glare removal etc.). The DVD format may be any suitable format such as, for example, PAL or interlaced recordings that are MPEG2 encoded. When video frames are extracted from a DVD VOB (Visual Object) files, the image data may be processed to be de-interlaced and/or cropped, and each frame may then be exported as a PNG (portable network graphics) file. The image frames may either come directly from a camera system (e.g. CCD camera), or directly from DVD VOB files, or the image frames may be extracted from a DVD recording that was made in a cystoscopy suite (again a VOB file).

The present invention may be put into practice by customising available hardware (e.g. retro-fitted standard systems), installing software application(s) on a suitable imaging system, or a single integrated system package may be provided ready for use, for example, in a clinical environment. However, it is understood by the person skilled in the art, that the present invention can be applied in any other suitable environment requiring endoscopic examination of internal cavities etc.

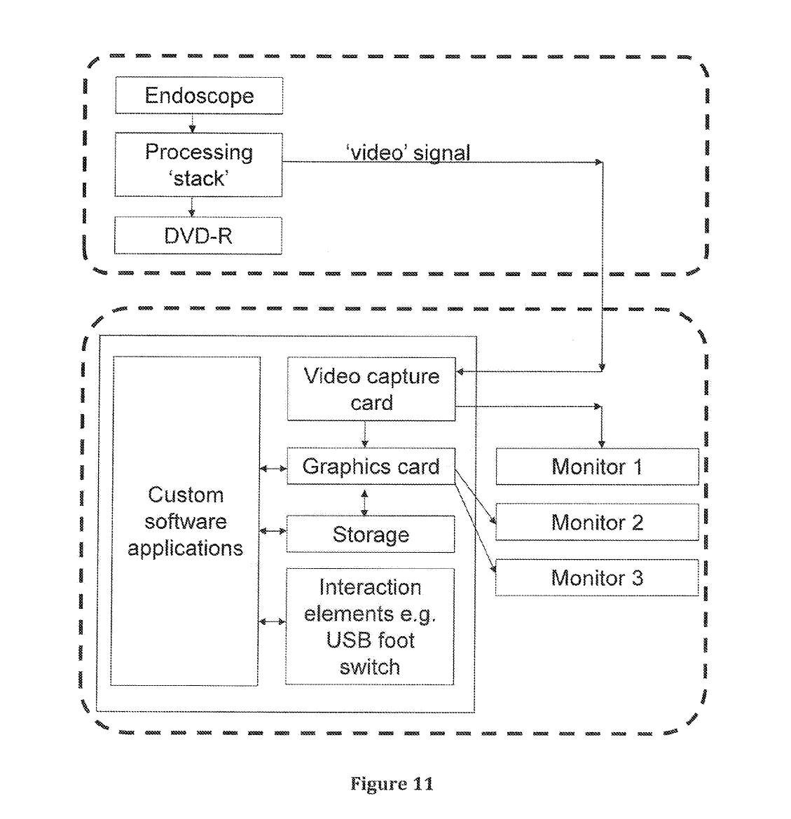

FIG. 11 shows an example setup of the endoscopic imaging system of the present invention where video images provided by the endoscope 302 are captured by a video capture card 304 which outputs the non-enhanced video images to monitor 1.

A graphics card 306 provides the video images to a processor 308 comprising software applications adapted to execute the method of the present invention (i.e. enhancing the video images utilising optimised LUTs). The enhanced video images are provided to monitor 2 and/or monitor 3 via graphics card 306, and are stored in a storage system 310. The endoscopic imaging system may include manual actuators, e.g. a foot switch, adapted to trigger system interactions such as, for example, still or video image capture, video pause, image zoom, and/or the selection of different image processing techniques.

It will be appreciated by persons skilled in the art that the above embodiment has been described by way of example only and not in any limitative sense, and that various alterations and modifications are possible without departing from the scope of the invention as defined by the appended claims.

1. A method for enhancing endoscopic image data, the method comprising:
(a) receiving a plurality of image frames from an imaging section of an endoscope apparatus at a predetermined frame rate;
(b) converting said plurality of image frames into a plurality of digital image frames at said predetermined frame rate;
(c) applying at least one active Look-up-Table, comprising at least one first transform, to at least part of said plurality of digital image frames at said predetermined frame rate, so as to generate a plurality of enhanced digital image frames;
(d) providing said enhanced digital image frames to a display at said predetermined frame rate;
(e) generating at least one optimized Look-up-Table, comprising at least one second transform that is optimized utilizing at least one image parameter of a predetermined quantity of said plurality of digital image frames;
(f) updating said at least one active Look-up-Table with said at least one second transform;
(g) executing step (c) for said predetermined quantity of a subsequent plurality of digital image frames;
(h) repeating steps (e) to (g) for successive integer multiples of said predetermined quantity of said plurality of digital image frames, and
wherein steps (e) to (h) are executed in parallel to steps (a) to (d).

2. The method according to claim 1, wherein said at least one active Look-up-Table comprises a plurality of spatially separated Look-up-Tables, each comprising respective said at least one first transform.

3. The method according to claim 2, wherein each one of said plurality of spatially separated Look-up-Tables is designated for a predetermined region of any one of said plurality of digital image frames.

4. The method according to claim 1, wherein step (f) includes generating a temporal sequence of a plurality of transition-transforms adapted to provide a smooth transition from said first transform of said active Look-up-Table to said second transform of said optimised Look-up-Table.

5. The method according to claim 4, wherein said smooth transition is executed over said predetermined quantity of said subsequent plurality of digital image frames.

6. The method according to claim 1, wherein step (e) is executed offline, utilizing a predetermined quantity of practice digital image frames.

7. The method according to claim 1, further comprising the step of:
(a-₁) initialising a first of said at least one active Look-up-Table prior to step (a).

8. The method according to claim 7, wherein said first of said at least one active Look-up-Table comprises a null-transform.

9. The method according to claim 8, wherein step (a-₁) is executed offline.

10. The method according to claim 1, wherein said at least one second transform is optimised utilizing any one of a gamma correction, histogram equalisation, contrast limited adaptive histogram equalisation, fixed contrast enhancement and feature segmentation by colour properties.

11. The method according to claim 1, wherein at least one of said at least one active Look-up-Table and said at least one optimised Look-up-Table are adapted to provide a predetermined transform at a predetermined threshold value of said at least one image parameter.

12. The method according to claim 1, wherein said at least one second transform is optimised according to a combination of R, G, B values of each one of said plurality of digital image frames.

13. The method according to claim 1, wherein said predetermined frame rate is a fixed frame rate.

14. An endoscopic imaging system adapted to enhance endoscopic image data by a method according to claim 1.

15. A non-transitory computer readable storage medium having embodied thereon a computer program, when executed by a computer processor that is configured to perform the method of claim 1.
